(19) United States
(12) Patent Application Publication
(10) Pub. No.: US 2026/0142809 A1
(43) Pub. Date: May 21, 2026

(54) DATA PROCESSING METHOD, ELECTRONIC DEVICE, AND STORAGE MEDIUM

(71) Applicant: Beijing Volcano Engine Technology Co., Ltd., Beijing (CN)

(72) Inventors: Bofeng WU, Beijing (CN); Dian Chen, Beijing (CN); Yu Lin, Beijing (CN); Ye Wu, Beijing (CN)

(21) Appl. No.: 19/351,068

(22) Filed: Oct. 6, 2025

(30) Foreign Application Priority Data
Nov. 19, 2024 (CN) 202411659318.0

(51) Int. Cl. H04L 9/08; H04L 9/32

(52) U.S. Cl. CPC H04L 9/0891; H04L 9/3234

(57) ABSTRACT

According to the embodiments of the present disclosure, a data processing method, an electronic device, and a non-transitory computer-readable storage medium are provided. The method includes: obtaining initial prompt information generated based on a user input at a client; encrypting the initial prompt information using a first key to obtain encrypted prompt information; retrieving, from a plurality of encrypted knowledge segments, at least one first encrypted knowledge segment matching the encrypted prompt information, wherein the plurality of encrypted knowledge segments are encrypted using the first key; and obtaining, using a machine learning model and based on the at least one first encrypted knowledge segment, a reply to the user input.

### CROSS-REFERENCE TO RELATED APPLICATION

This application claims priority of the Chinese Patent Application No. 202411659318.0 filed on November 19, 2024, the content disclosed in which is incorporated herein by reference in their entirety.

### TECHNICAL FIELD

Example implementations of the present disclosure generally relate to the field of computers, and in particular, to a method, an apparatus, a device, and a storage medium for data processing.

### BACKGROUND

With the increasing importance of data security, improving data security has become an urgent issue that needs to be addressed. In particular, in the process of data interaction between a user terminal and a cloud, how to ensure the security of data generated by the user terminal is a problem that needs to be solved.

### SUMMARY

In a first aspect of the present disclosure, a data processing method is provided. The method includes: obtaining initial prompt information generated based on a user input at a client; encrypting the initial prompt information using a target key (for example, a first key) to obtain encrypted prompt information; retrieving, from a plurality of encrypted knowledge segments, at least one target encrypted knowledge segment (for example, at least one first encrypted knowledge segment) matching the encrypted prompt information, the plurality of encrypted knowledge segments being encrypted using the target key; and obtaining, using a machine learning model and based on the at least one target encrypted knowledge segment, a reply to the user input.

In a second aspect of the present disclosure, a data processing method is provided. The method is applied at a client and includes: presenting a key configuration interface; configuring a target key based on a target operation (for example, a first operation) on the key configuration interface; and sending the target key to a key management service in response to the key management service passing verification.

In a third aspect of the present disclosure, a data processing method is provided. The method is applied at a key management service and includes: receiving a target key from a client; receiving, from a knowledge service, a key request for the target key; and sending the target key to the knowledge service.

In a fourth aspect of the present disclosure, a data processing apparatus is provided. The apparatus includes: a prompt information obtaining module configured to obtain initial prompt information generated based on a user input at a client; a prompt information encryption module configured to encrypt the initial prompt information using a target key to obtain encrypted prompt information; a retrieval module configured to retrieve, from a plurality of encrypted knowledge segments, at least one target encrypted knowledge segment matching the encrypted prompt information, the plurality of encrypted knowledge segments being encrypted using the target key; and a reply obtaining module configured to obtain, using a machine learning model and based on the at least one target encrypted knowledge segment, a reply to the user input.

In a fifth aspect of the present disclosure, a data processing apparatus is provided. The apparatus is applied at a client and includes: a configuration interface presenting module configured to present a key configuration interface; a key configuration module configured to configure a target key based on a target operation on the key configuration interface; and a first key sending module configured to send the target key to a key management service in response to the key management service passing verification.

In a sixth aspect of the present disclosure, a data processing apparatus is provided. The apparatus is applied at a key management service and includes: a key receiving module configured to receive a target key from a client; a request receiving module configured to receive, from a knowledge service, a key request for the target key; and a second key sending module configured to send the target key to the knowledge service.

In a seventh aspect of the present disclosure, an electronic device is provided. The device includes at least one processing unit; and at least one memory coupled to the at least one processing unit and storing instructions executable by the at least one processing unit, the instructions, when executed by the at least one processing unit, causing the device to perform the method of the first aspect, the second aspect, or the third aspect.

In an eighth aspect of the present disclosure, a computer-readable storage medium is provided. The computer-readable storage medium has a computer program stored thereon, the computer program being executable by a processor to implement the method of the first aspect, the second aspect, or the third aspect.

It should be understood that the content described in this section is neither intended to identify key or essential features of the implementations of the present disclosure, nor is it intended to limit the scope of the present disclosure. Other features of the present disclosure will be readily envisaged through the following description.

### BRIEF DESCRIPTION OF DRAWINGS

The foregoing and other features, advantages, and aspects of the implementations of the present disclosure become more apparent with reference to the following detailed description and in conjunction with the drawings. In the drawings, the same or similar reference numerals denote the same or similar elements.

FIG. 1 illustrates a schematic diagram of an example environment in which the implementations of the present disclosure may be implemented;

FIG. 2 illustrates a schematic diagram of an example interaction procedure of data processing according to some embodiments of the present disclosure;

FIG. 3 illustrates a schematic diagram of an example interaction scenario of data processing according to some embodiments of the present disclosure;

FIG. 4 illustrates a flowchart of a procedure of data processing applied to a knowledge service according to some embodiments of the present disclosure;

FIG. 5 illustrates a flowchart of a procedure of data processing applied to a client according to some embodiments of the present disclosure;

FIG. 6 illustrates a flowchart of a procedure of data processing applied to a key management service according to some embodiments of the present disclosure;

FIG. 7 illustrates a block diagram of an apparatus for data processing applied to a knowledge service according to some embodiments of the present disclosure;

FIG. 8 illustrates a block diagram of an apparatus for data processing applied to a client according to some embodiments of the present disclosure;

FIG. 9 illustrates a block diagram of an apparatus for data processing applied to a key management service according to some embodiments of the present disclosure; and

FIG. 10 illustrates a block diagram of a device capable of implementing a plurality of embodiments of the present disclosure.

### DETAILED DESCRIPTION

The implementations of the present disclosure are described in more detail below with reference to the drawings. Although some implementations of the present disclosure are shown in the drawings, it should be understood that the present disclosure may be implemented in various forms and should not be construed as being limited to the implementations set forth herein. Instead, these implementations are provided for a more thorough and complete understanding of the present disclosure. It should be understood that the drawings and implementations of the present disclosure are only for exemplary purposes, and are not intended to limit the scope of protection of the present disclosure.

In the description of the implementations of the present disclosure, the term "include/comprise" and similar terms thereof should be understood as open-ended inclusions, that is, "include/comprise but not limited to". The term "based on" should be understood as "at least partially based on". The term "an implementation" or "the implementation" should be understood as "at least one implementation". The term "some implementations" should be understood as "at least some implementations". Other definitions, both explicit and implicit, may be included below.

In this specification, unless explicitly stated, "in response to A" to perform a step does not mean that the step is performed immediately after "A", and one or more intermediate steps may be included.

It may be understood that the data involved in the technical solution (including but not limited to the data itself, acquisition, use, storage, or deletion of the data) should comply with requirements of corresponding laws, regulations, and related provisions.

It may be understood that before the use of the technical solution disclosed in the implementations of the present disclosure, the type, range of use, use scenarios, etc., of information involved in the present disclosure should be informed to a related user in an appropriate manner and the authorization of the related user should be obtained according to related laws and regulations, where the related user may include any type of subject of rights, for example, an individual, an enterprise, or a group.

For example, in response to reception of an active request from a user, prompt information is sent to the related user to clearly inform the related user that the requested operation will require access to and use of information of the related user, so that the related user may independently choose, based on the prompt information, whether to provide the information to software or hardware, such as an electronic device, an application, a server, or a storage medium, that performs the operations of the technical solution of the present disclosure.

As an optional but non-restrictive implementation, in response to the reception of the active request from the related user, the prompt information may be sent to the related user in the form of, for example, a pop-up window, in which the prompt information may be presented in text. In addition, the pop-up window may also include a selection control for the user to choose whether to "agree" or "disagree" to provide the information to the electronic device.

It may be understood that the above process of notifying and obtaining user authorization is only illustrative, and does not limit the implementations of the present disclosure. Other manners that satisfy the related laws and regulations may also be applied to the implementations of the present disclosure.

As briefly described above, in order to better use services such as a large model on the cloud, the user needs to transmit some data at his/her disposal to the cloud, to provide retrieval augmentation for the services such as a machine learning model. At present, after a user uploads a local document from a client to the cloud, a cloud service will perform vectorization on the document and store a vector result in a database on the cloud. When the storage is completed, the user will view a status synchronization result on the client indicating that a knowledge base has been successfully created. Subsequently, the user may initiate client-cloud interaction based on the customized knowledge base on the client, and the database is retrieved based on a user request such as a keyword. Then, the retrieval result and the user request are input into a large model service for fine-tuning, and finally the result is returned to the client. However, in the above process, data in the knowledge base created by the user on the cloud is stored in plaintext, which entails a risk of leakage.

According to the embodiments of the present disclosure, an improved solution for data processing is provided. In this solution, a knowledge service first obtains initial prompt information generated based on a user input at a client, and encrypts the initial prompt information using a target key to obtain encrypted prompt information. The knowledge service then retrieves, from a plurality of encrypted knowledge segments, at least one target encrypted knowledge segment matching the encrypted prompt information, the plurality of encrypted knowledge segments being encrypted using the target key. The knowledge service then obtains, using a machine learning model and based on the at least one target encrypted knowledge segment, a reply to the user input.

Through the above process, the knowledge service may encrypt the knowledge segment before storing it, and perform encrypted retrieval on the knowledge segment by encrypting the initial prompt information using the same key. Through these improvements, the risk of leakage of data resources in plaintext during storage and transmission may be reduced, thereby solving the data security problem.

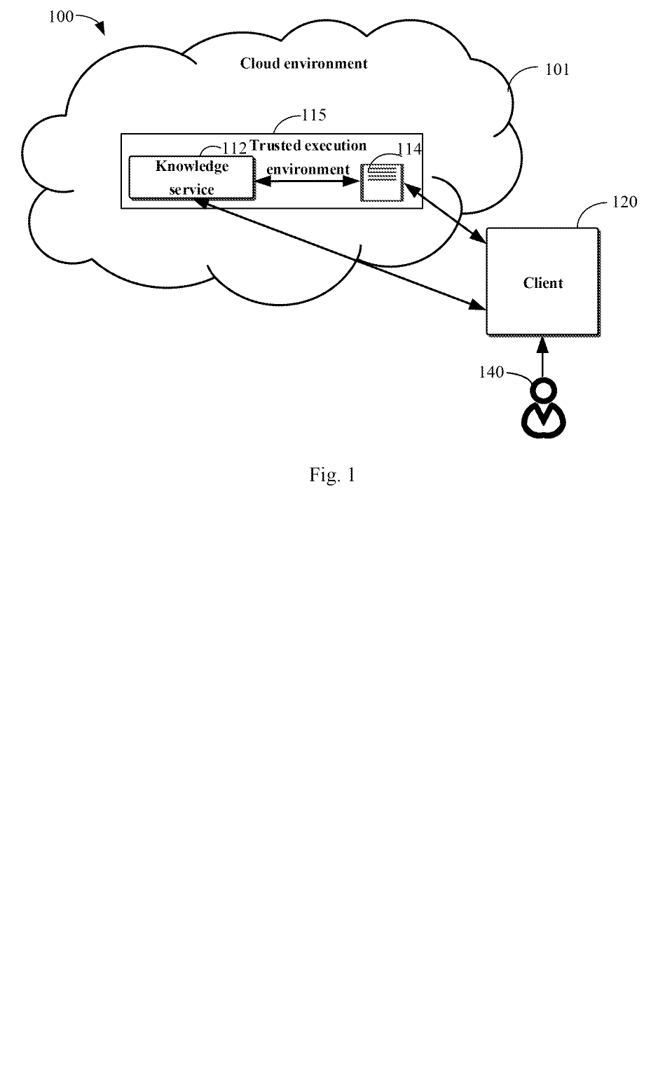

FIG. 1 illustrates a schematic diagram of an example environment 100 in which the embodiments of the present disclosure may be implemented. As shown in FIG. 1, the example environment 100 may include a client 120 of a user 140 and a cloud environment 101.

As shown in FIG. 1, a trusted execution environment 115 may be deployed in the cloud environment 101. The trusted execution environment (TEE) is a hardware-based security technology that constructs a secure computing environment isolated from the outside by dividing a security part and a non-security part. The secure computing environment may ensure the confidentiality and integrity of data and code loaded in the trusted execution environment 115. The trusted execution environment 115 is isolated from a normal environment, and has a higher security level, and is suitable for performing processing on sensitive data. Private cloud computing (PCC) may run in the trusted execution environment 115. Private cloud computing is a TEE-based security computing framework on the cloud, which aims to build a set of security computing services trusted by users, provide users with a secure and reliable running environment on the cloud, and ensure the security of the entire link of client-cloud collaboration.

The knowledge service 112 may be deployed in the trusted execution environment 115. The knowledge service may be a retrieval-augmented generation (RAG) service. RAG may retrieve relevant information based on a large-scale knowledge source (such as a document, a knowledge base, etc.), and then use the retrieved relevant information as a context to assist a language model to generate text. Secure RAG is a RAG security enhancement service running in PCC. Secure RAG may support encrypted storage of plaintext vectors in a knowledge source and retrieval in ciphertext vectors to avoid knowledge leakage caused by plaintext storage.

A key management service may be deployed in the trusted execution environment 115. With the key management service, the key of the user 140 obtained from the client 120 may be stored in the key management service 114. The trusted key service (TKS) is a secure key service running in PCC, which aims to provide users with key management and agency services based on hardware protection.

The knowledge service 112 may communicate with the key management service 114. For example, the knowledge service 112 may send a key request to the key management service 114 to obtain a target key to encrypt or decrypt knowledge.

In some embodiments, the trusted execution environment 115 may communicate with the client 120 to implement data access and analysis. The client 120 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination thereof, including accessories and peripherals of these devices or any combination thereof. In some embodiments, the client 120 may also support any type of user-specific interface (such as "wearable" circuitry, etc.).

The cloud environment 101 may include an independent physical server, a server cluster or a distributed system composed of a plurality of physical servers, or may include a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms, etc. The trusted execution environment 115 may be implemented by using a host device in the cloud environment 101. The host device may include, for example, a computing system/server, such as a mainframe, an edge computing node, a computing device in a cloud environment, and so on. The host device may provide the client 120 with a backstage service for data management.

A communication connection may be established between the cloud environment 101 and the client 120. The communication connection may be established in a wired or wireless manner. The communication connection may include, but is not limited to, a Bluetooth connection, a mobile network connection, a universal serial bus connection, a Wi-Fi connection, etc. The embodiments of the present disclosure are not limited in this regard.

It should be understood that the structure and function of each element in the environment 100 are described for exemplary purposes only, without suggesting any limitation to the scope of the present disclosure. In other words, the structure, function, number, and linking relationship of the elements in the environment 100 may be changed according to actual needs. The present disclosure is not limited in this regard.

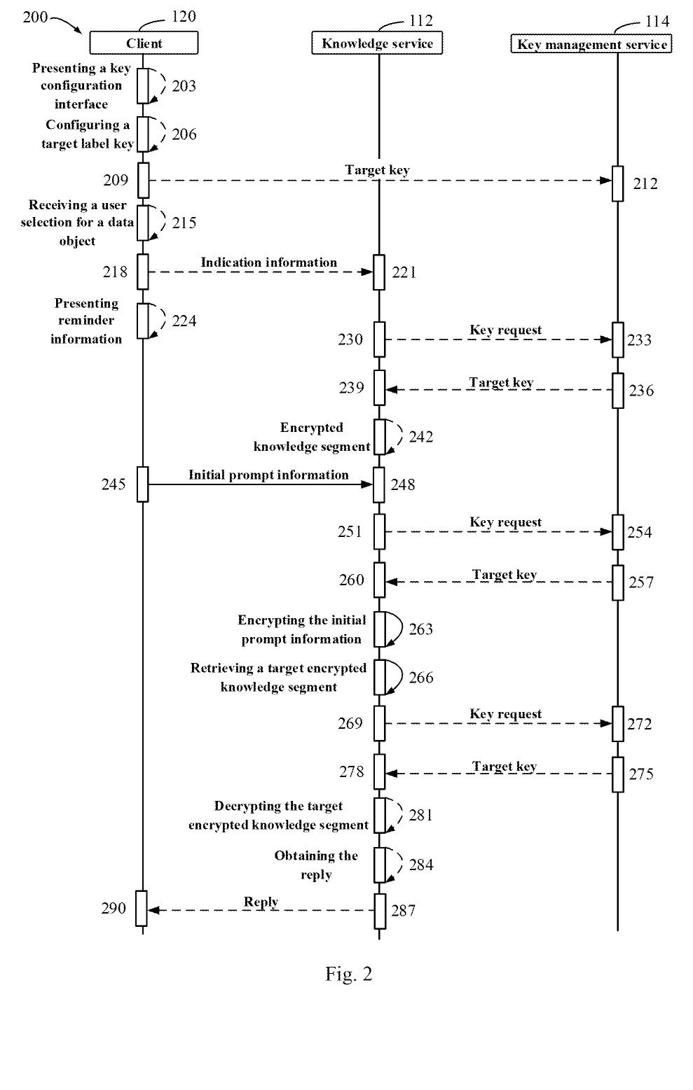

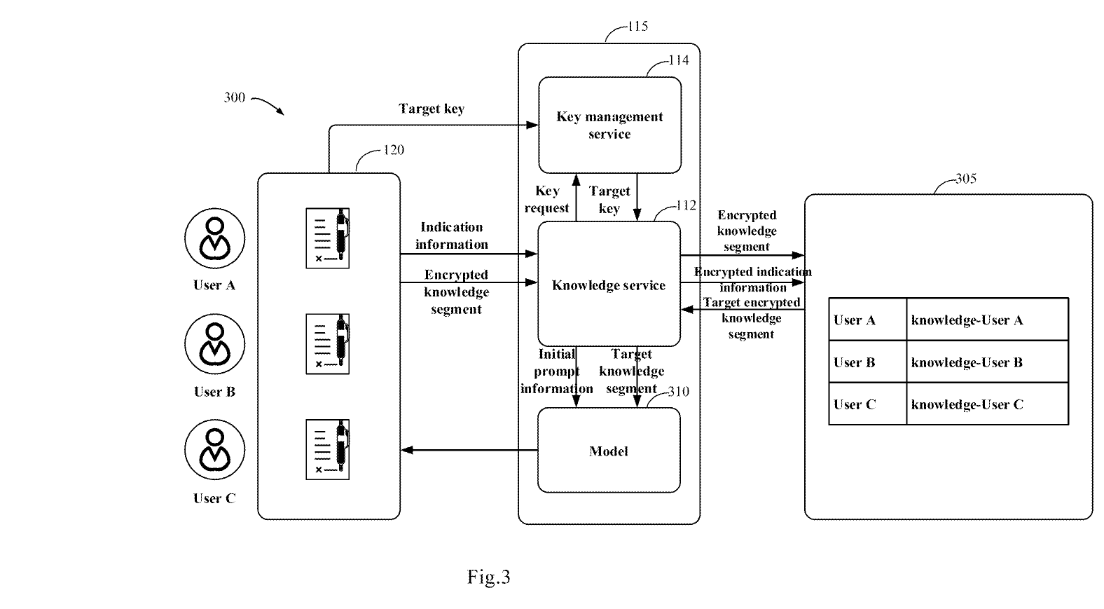

Some example embodiments of the present disclosure are described in detail below with reference to the examples in FIG. 2 and FIG. 3.

FIG. 2 illustrates an example interaction procedure 200 of data processing according to some embodiments of the present disclosure. The interaction procedure 200 includes the client 120, the knowledge service 112, and the key management service 114. FIG. 3 illustrates an example interaction scenario 300 of data processing according to some embodiments of the present disclosure. The interaction scenario 300 includes the client 120, the knowledge service 112, the key management service 114, a database 305, and a machine learning model 310. For ease of discussion, the interaction procedure 200 and the interaction scenario 310 are described with reference to the environment 100 in FIG. 1. It may be understood that the knowledge service 112 is only exemplary, and the methods and steps implemented at the knowledge service 112 described herein may also be applied to other services or functions.

As shown in FIG. 3, at the client 120, a corresponding key may be set for each user. In some embodiments, the key may be set based on a user input. Alternatively or in addition, the key may be set by way of random generation. In the case where the key is set based on the user input, as shown in FIG. 2, the client 120 may present (203) a key configuration interface and configure (206) a target key based on a target operation on the key configuration interface. For example, the key configuration interface may include a key input box, and the client 120 may configure the target key of the user 140 based on an input operation of the user 140 in the input box. The target key may be used for knowledge management related to the client 120. For example, the target key may be used to encrypt or decrypt data uploaded by the user 140 at the client 120, as described below.

In some embodiments, the client 120 may verify the key management service 114. As an example, the key management service 114 may send a proof report to the client 120. The proof report may indicate the trustworthiness of an environment in which the target key is stored. The client 120 may receive the proof report and verify the key management service 114 based on the proof report. For example, the client 120 may determine that the key management service 114 passes the verification and send the key to the key management service 114 when the proof report indicates that an execution environment in which the key management service 114 is located is trustworthy. The verification manner described here is only exemplary and not intended to be any limitation, and the embodiments of the present disclosure are not limited in this regard.

If the key management service 114 passes the verification, the client 120 may send (209) the target key to the key management service 114. Correspondingly, the key management service 114 may receive (212) the target key from the client 120. The key management service 114 may store and manage the received key. In some embodiments, the key management service 114 may be deployed in the trusted execution environment 115 to improve the security of key storage and management.

After the key for knowledge management is configured, the user 140 may interact with the knowledge service 112 through the client 120. As shown in FIG. 2, in some embodiments, the client 120 may receive (215) a user selection for a data object. For example, the client 120 may present a configuration interface of the data object, and may receive the user selection for the data object based on the user’s operations on the interface, such as selection, input, pasting, etc. The data object may include various types of objects such as a document and a dataset. The data object selected by the user may be a local data object of the client, or a remotely or online stored data object. The data object selected by the user may be used to create a knowledge segment to be provided to a cloud service that the user needs. In some embodiments, in response to the user selection, the client 120 may send (218) indication information for the data object to the knowledge service 112. The indication information may include any information that may be used to access and obtain the data object. For example, if the data object selected by the user is an online document, the indication information may be a link, a storage location, etc., of the online document. For another example, if the data object selected by the user is a local document of the client, the indication information may include the document itself.

In some embodiments, in response to the sending of the indication information, the client 120 may present reminder information indicating that the knowledge segment created based on the data object will be encrypted. The reminder information may remind the user that the knowledge content he/she selected will be stored and used in an encrypted form.

Correspondingly, the knowledge service 112 may receive (221) the indication information for the data object, to obtain the data object selected by the user. Next, the knowledge service 112 may generate a knowledge segment based on the obtained data object. In some embodiments, the knowledge service 112 may perform vectorization on at least one part of the data object to obtain at least one knowledge segment for the data object. For example, in the case where the data object is a document, the knowledge service may perform vectorization on each paragraph or each sentence of the document to obtain a plaintext vector for the paragraph or sentence as a knowledge segment for the data object.

In some embodiments, the knowledge service 112 may encrypt the knowledge segment using a key. In some embodiments, the key may be randomly generated by the knowledge service 112. In some embodiments, the key may be hosted by the user 140 at the key management service 114. For example, the knowledge service 112 may send (230) a key request to the key management service 114. In some embodiments, the key request may indicate a purpose of use of the key, that is, indicate that the requested key will be used for knowledge segment generation. The key management service 114 may receive (233) the key request and send (236) a target key to the knowledge service 112.

In some embodiments, after receiving (239) the target key, the knowledge service 112 may use the target key to encrypt (242) the at least one knowledge segment to obtain at least one encrypted knowledge segment. The knowledge service 112 may use the at least one encrypted knowledge segment as described above as at least a part of the plurality of encrypted knowledge segments to construct the plurality of encrypted knowledge segments for the user.

In some embodiments, as shown in FIG. 3, the knowledge service 112 may store the encrypted knowledge segment in the database 305. For example, the encrypted knowledge segment may be stored in an encrypted knowledge base. The database 305 may be a database in a trusted execution environment or a database in a normal cloud environment. The database 305 may store a plurality of encrypted knowledge segments for a user A, a user B, and a user C, respectively. It may be understood that the knowledge segments stored in the database 305 by different users may be encrypted, partially encrypted, or unencrypted.

In some embodiments, the client 120 may send (245) to the knowledge service 112 the initial prompt information generated based on the user input at the client 120. The initial prompt information represents unencrypted, plaintext prompt information. For example, the initial prompt information may be an inference request input by the user 140. For another example, the initial prompt information may be generated based on the inference request and relevant contextual information. In some embodiments, the above-mentioned indication information for the data object may be sent by a second user, and the user input may be sent by a first user. The second user may be the first user or a user related to the first user. For example, the second user may be a creator of the knowledge base, and the first user may be a user authorized by the second user to use the knowledge base. After receiving (248) the initial prompt information, the knowledge service 112 may encrypt the initial prompt information using the above-mentioned target key for encrypting the knowledge segment, to obtain the encrypted prompt information. The encrypted prompt information may be used to retrieve the encrypted knowledge segment.

In some embodiments, the target key used for encryption may be from the key management service 114. As shown in FIG. 2, in response to obtaining the initial prompt information, the knowledge service 112 may send (251) a key request for the target key to the key management service 114. In some embodiments, the key request may indicate a purpose of use of the key, that is, indicate that the requested key will be used for encrypting the prompt information. The key management service 114 may receive (254) the key request and send (257) the target key to the knowledge service 112. In some embodiments, after receiving (260) the target key, the knowledge service 112 uses the target key to encrypt (263) the initial prompt information to obtain the encrypted prompt information. Specifically, the knowledge service 112 may perform vectorization on the initial prompt information to obtain vectorized prompt information, and encrypt the vectorized prompt information using the target key to obtain the encrypted prompt information.

In some embodiments, the knowledge service 112 retrieves (266), from the plurality of encrypted knowledge segments, the at least one target encrypted knowledge segment matching the encrypted prompt information, and obtains, using the machine learning model and based on the at least one target encrypted knowledge segment, the reply to the user input. For example, the encrypted knowledge segment may be retrieved from the encrypted knowledge base. In some embodiments, as shown in FIG. 3, the knowledge service 112 sends the encrypted prompt information to the database 305, to retrieve, from the plurality of encrypted knowledge segments stored in the database 305, the at least one target encrypted knowledge segment matching the encrypted prompt information. It may be understood that because the encrypted prompt information and the encrypted knowledge segment are encrypted using the same key, it may be considered that they have undergone the same transformation in the vector space compared with the unencrypted prompt information and the unencrypted knowledge segment. In this case, the impact of encryption on the retrieval accuracy is minimal. That is, such encrypted retrieval does not affect the effect of knowledge retrieval.

After the retrieval is completed, the knowledge service 112 obtains the reply to the user input based on the at least one retrieved target encrypted knowledge segment. In some embodiments, in response to the retrieval of the at least one target encrypted knowledge segment, the knowledge service 112 may send (269) a key request for the target key to the key management service 114. In some embodiments, the key request may indicate a purpose of use of the key, that is, indicate that the requested key will be used to decrypt the encrypted knowledge segment. The key management service 114 may receive (272) the key request and send (275) the target key to the knowledge service 112. In some embodiments, after receiving (278) the target key, the knowledge service 112 may use the received target key to decrypt (281) the at least one target encrypted knowledge segment to obtain at least one target knowledge segment, and obtain (284) the reply to the user input based on the at least one target knowledge segment and the initial prompt information.

For example, referring to FIG. 3, the knowledge service 112 may provide the initial prompt information and the at least one target knowledge segment to the machine learning model 310 deployed in the trusted execution environment 115, to obtain an output of the machine learning model 310. In an example, the machine learning model 310 may be a large language model (LLM). The knowledge service 112 may determine the reply to the user input based on the output of the machine learning model, and send (287) the reply to the client 120. For example, the knowledge service 112 may provide the initial prompt information and the at least one target knowledge segment to the LLM, and determine the reply to the user input based on an output of the LLM. The client 120 may receive (290) the reply and present it to the customer 140. In some embodiments, after the reply to the user input is determined, the knowledge service 112 may delete the target key and the at least one retrieved target knowledge segment.

In some embodiments, the target key may be obtained based on configuration of a target user who sends the user input at the client 120. That is, the target user may configure the key at the client 120 and host it at the key management service 114. When processing knowledge corresponding to the target user, the knowledge service 114 requests the target key of the target user from the key management service 114. Because the data in the database 305 is stored in ciphertext and the target key is under the control of the target user, data leakage of the target user may be avoided.

In the example in FIG. 2, the knowledge service 112 sends the key request to the key management service 114 three times before encrypting (242) the knowledge segment, encrypting (263) the initial prompt information, and decrypting (281) the target encrypted knowledge segment, to obtain the target key. In this way, the knowledge service 112 may delete the target key in time after each encryption or decryption operation is completed, to reduce the risk of the target key being leaked. It may be understood that the knowledge service 112 may also send only one key request to the key management service 114. After receiving the target key, the key management service 114 stores the target key for subsequent encryption or decryption.

In some embodiments, the key request sent by the knowledge service 112 to the key management service 114 may include authorization information for the target key. The authorization information is obtained by the knowledge service 112 from the client 120. The key management service 114 may send the target key to the knowledge service 112 based on the authorization information in the key request passing the verification.

In some embodiments, the knowledge service 112 may be deployed in the trusted execution environment 115. Alternatively, the knowledge service 112 may also be deployed in a normal execution environment. In the case where the knowledge service 112 is deployed in the trusted execution environment, the key request may include a security report. The security report indicates the trustworthiness of the environment in which the knowledge service 112 is deployed.

Although the knowledge service 112, the key management service 114, and the model 310 are shown in the same trusted execution environment 115 in the example in FIG. 3, it should be understood that the scenario shown in FIG. 3 is only exemplary and not intended to be any limitation. The knowledge service 112, the key management service 114, the model 310, and the database 305 may be deployed in the same trusted execution environment, or may be deployed in different trusted execution environments, respectively. Alternatively, a part of the knowledge service 112, the key management service 114, the model 310, and the database 305 may be deployed in the same trusted execution environment. For example, the knowledge service 112 and the model 310 may be deployed in the same trusted execution environment, and the key management service 114 and the database 305 may be deployed in the same or different trusted execution environments.

The embodiments of the present disclosure may encrypt the knowledge segment before storing it, and encrypt the initial prompt information using the same key to implement encrypted retrieval of the knowledge segment. Through these improvements, the risk of leakage of plaintext data resources during storage and transmission may be reduced, thereby solving the data security problem.

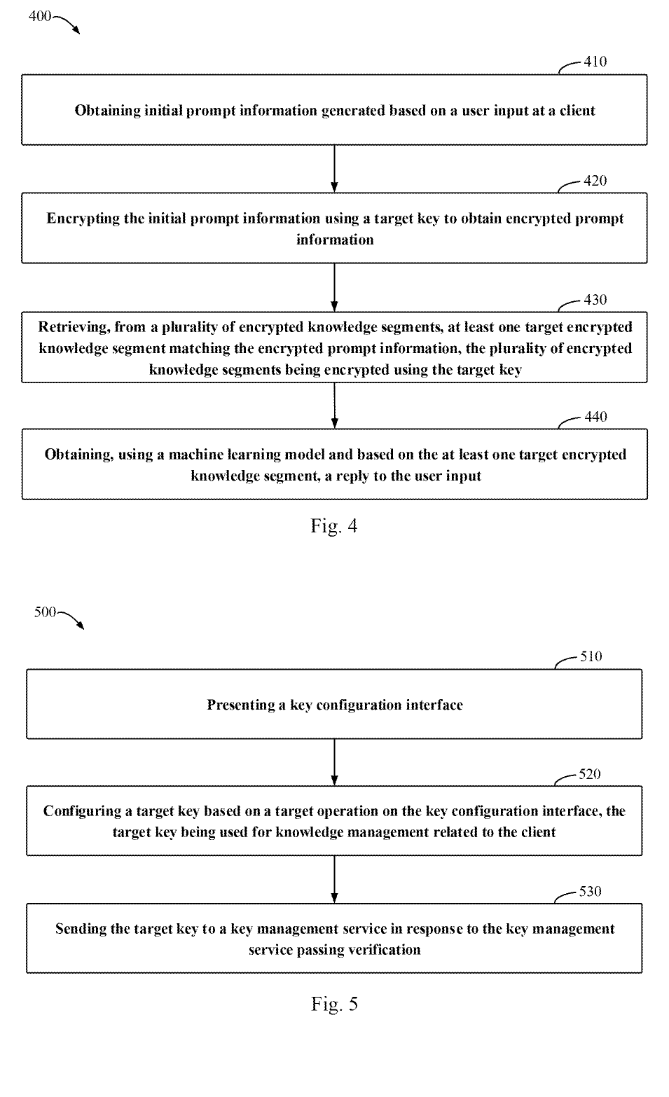

FIG. 4 illustrates a flowchart of a process 400 of data processing according to some embodiments of the present disclosure. The process 400 may be applied to the knowledge service 112. The process 400 is described below with reference to FIG. 1.

At block 410, the knowledge service 112 obtains initial prompt information generated based on a user input at the client 120.

At block 420, the knowledge service 112 encrypts the initial prompt information using a target key to obtain encrypted prompt information.

At block 430, the knowledge service 112 retrieves, from a plurality of encrypted knowledge segments, at least one target encrypted knowledge segment matching the encrypted prompt information, the plurality of encrypted knowledge segments being encrypted using the target key.

At block 440, the knowledge service 112 obtains, using a machine learning model and based on the at least one target encrypted knowledge segment, a reply to the user input.

In some embodiments, the knowledge service 112 may use the target key to decrypt the at least one target encrypted knowledge segment to obtain at least one target knowledge segment, and obtain the reply to the user input based on the at least one target knowledge segment and the initial prompt information.

In some embodiments, the user input may be sent by a first user, and the knowledge service 112 may receive indication information for a data object from a second user, the data object being used for knowledge segment creation; obtain at least one knowledge segment for the data object by performing vectorization on at least one part of the data object; and encrypt the at least one knowledge segment using the target key to obtain at least one encrypted knowledge segment as at least a part of the plurality of encrypted knowledge segments.

In some embodiments, the knowledge service 112 may send a key request for the target key to a key management service in response to obtaining the initial prompt information, and receive the target key from the key management service.

In some embodiments, the knowledge service 112 may send a key request for the target key to the key management service in response to the retrieval of the at least one target encrypted knowledge segment; and receive the target key from the key management service.

In some embodiments, the target key is obtained based on configuration at the client of a target user who sends the user input.

In some embodiments, the knowledge service 112 may perform vectorization on the initial prompt information to obtain vectorized prompt information, and encrypt the vectorized prompt information using the target key to obtain the encrypted prompt information.

In some embodiments, the knowledge service 112 may provide the initial prompt information and the at least one target knowledge segment to a machine learning model deployed in a trusted execution environment to obtain an output of the machine learning model, and determine the reply to the user input based on the output of the machine learning model.

In some embodiments, the process 400 is performed in a trusted execution environment.

FIG. 5 illustrates a flowchart of a process 500 of data processing according to some embodiments of the present disclosure. The process 500 may be applied to the client 120. The process 500 is described below with reference to FIG. 1.

At block 510, the client 120 presents a key configuration interface.

At block 520, the client 120 configures a target key based on a target operation on the key configuration interface.

At block 530, the client 120 sends the target key to a key management service in response to the key management service passing verification.

In some embodiments, the client 120 may receive a user selection for a data object, the data object being used for knowledge segment creation; send indication information for the data object to a knowledge service in response to the user selection; and present reminder information indicating that a knowledge segment created based on the data object will be encrypted.

In some embodiments, the client 120 may receive a proof report from the key management service, the proof report indicating the trustworthiness of an environment in which the target key is stored; and verify the key management service based on the proof report.

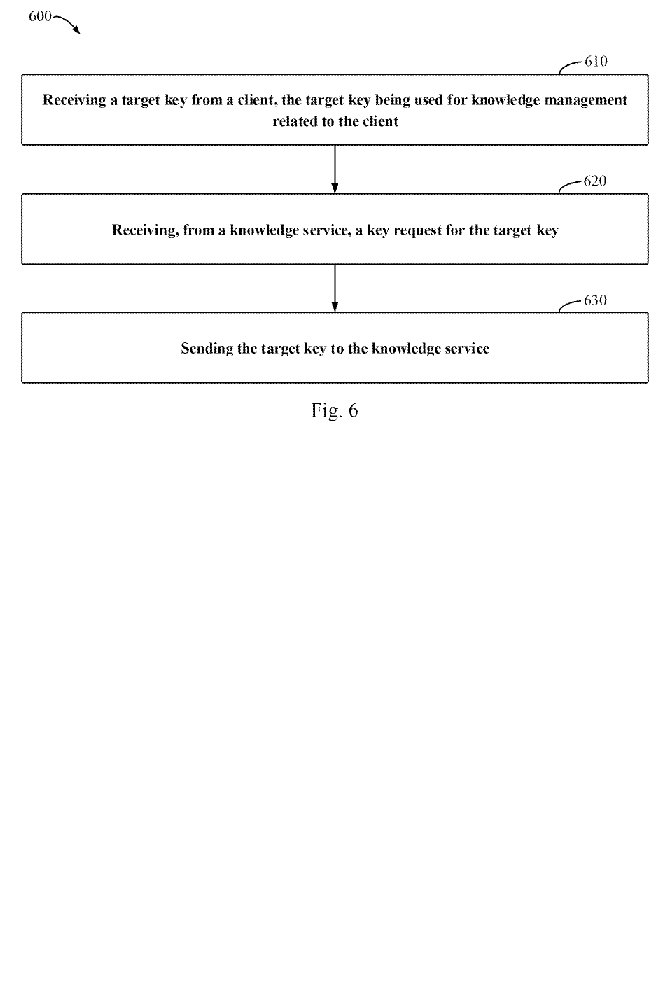

FIG. 6 illustrates a flowchart of a process 600 for data processing according to some embodiments of the present disclosure. The process 600 may be applied to the key management service 114. The process 600 is described below with reference to FIG. 1.

At block 610, the key management service 114 receives a target key from a client.

At block 620, the key management service 114 receives, from a knowledge service, a key request for the target key.

At block 630, the key management service 114 sends the target key to the knowledge service.

In some embodiments, the key management service 114 may send a proof report to the client, the proof report indicating the trustworthiness of an environment in which the target key is stored.

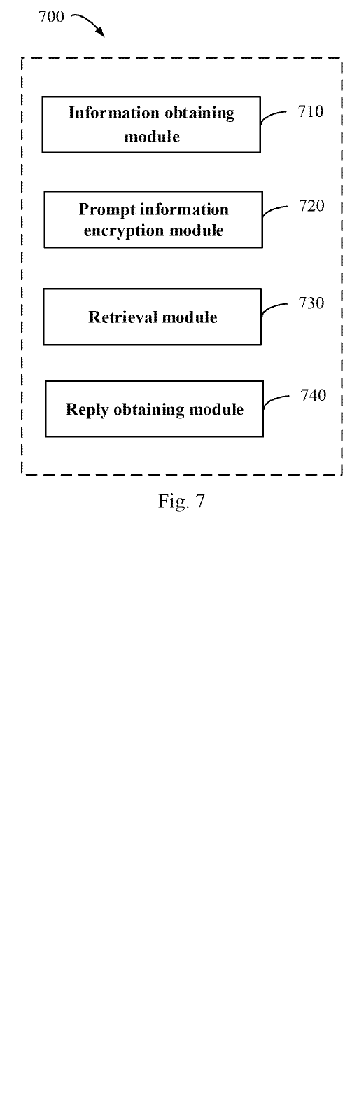

FIG. 7 illustrates a schematic structural block diagram of an apparatus 700 for data processing according to some embodiments of the present disclosure. The apparatus 700 may be applied to the knowledge service 112. Each module/component in the apparatus 700 may be implemented by hardware, software, firmware, or any combination thereof.

As shown in FIG. 7, the apparatus 700 includes a prompt information obtaining module 710 configured to obtain initial prompt information generated based on a user input at a client. The apparatus 700 further includes a prompt information encryption module 720 configured to encrypt the initial prompt information using a target key to obtain encrypted prompt information. The apparatus 700 further includes a retrieval module 730 configured to retrieve, from a plurality of encrypted knowledge segments, at least one target encrypted knowledge segment matching the encrypted prompt information, the plurality of encrypted knowledge segments being encrypted using the target key. The apparatus 700 further includes a reply obtaining module 740 configured to obtain, using a machine learning model and based on the at least one target encrypted knowledge segment, a reply to the user input.

In some embodiments, the reply obtaining module 740 is further configured to use the target key to decrypt the at least one target encrypted knowledge segment to obtain at least one target knowledge segment, and obtain the reply to the user input based on the at least one target knowledge segment and the initial prompt information.

In some embodiments, the user input is sent by a first user, and the apparatus 700 further includes a knowledge segment encryption module configured to receive indication information for a data object from a second user, the data object being used for knowledge segment creation; obtain at least one knowledge segment for the data object by performing vectorization on at least one part of the data object; and encrypt the at least one knowledge segment using the target key to obtain at least one encrypted knowledge segment as at least a part of the plurality of encrypted knowledge segments.

In some embodiments, the apparatus 700 further includes a target key obtaining module configured to send a key request for the target key to a key management service in response to obtaining the initial prompt information, and receive the target key from the key management service.

In some embodiments, the target key obtaining module is further configured to send a key request for the target key to the key management service in response to the retrieval of the at least one target encrypted knowledge segment, and receive the target key from the key management service.

In some embodiments, the target key is obtained based on configuration at the client of a target user who sends the user input.

In some embodiments, the prompt information encryption module 720 is further configured to perform vectorization on the initial prompt information to obtain vectorized prompt information, and encrypt the vectorized prompt information using the target key to obtain the encrypted prompt information.

In some embodiments, the reply obtaining module 740 is further configured to provide the initial prompt information and the at least one target knowledge segment to a machine learning model deployed in a trusted execution environment to obtain an output of the machine learning model, and determine the reply to the user input based on the output of the machine learning model.

In some embodiments, the apparatus 700 is executed in a trusted execution environment.

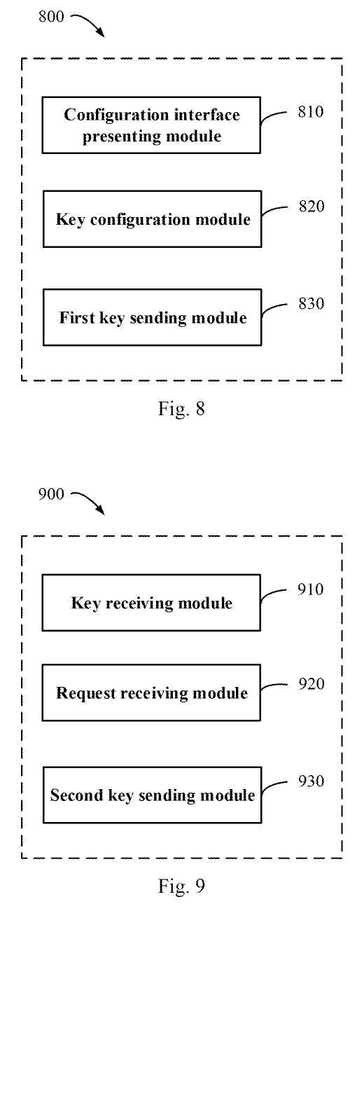

FIG. 8 illustrates a schematic structural block diagram of an apparatus 800 for data processing according to some embodiments of the present disclosure. The apparatus 800 may be applied to the client 120. Each module/component in the apparatus 800 may be implemented by hardware, software, firmware, or any combination thereof.

As shown in FIG. 8, the apparatus 800 includes a configuration interface presenting module 810 configured to present a key configuration interface. The apparatus 800 further includes a key configuration module 820 configured to configure a target key based on a target operation on the key configuration interface. The apparatus 800 further includes a first key sending module 830 configured to send the target key to a key management service in response to the key management service passing verification.

In some embodiments, the apparatus 800 further includes a user selection receiving module configured to receive a user selection for a data object, the data object being used for knowledge segment creation; send indication information for the data object to a knowledge service in response to the user selection; and present reminder information indicating that a knowledge segment created based on the data object will be encrypted.

In some embodiments, the apparatus 800 further includes a key request verification module configured to receive a proof report from the key management service, the proof report indicating the trustworthiness of an environment in which the target key is stored; and verify the key management service based on the proof report.

FIG. 9 illustrates a schematic structural block diagram of an apparatus 900 for data processing according to some embodiments of the present disclosure. The apparatus 900 may be applied to the key management service 114. Each module/component in the apparatus 900 may be implemented by hardware, software, firmware, or any combination thereof.

As shown in FIG. 9, the apparatus 900 includes a key receiving module 910 configured to receive a target key from a client. The apparatus 900 further includes a request receiving module 920 configured to receive, from a knowledge service, a key request for the target key. The apparatus 900 further includes a second key sending module 930 configured to send the target key to the knowledge service.

In some embodiments, the apparatus 900 further includes a verification report sending module configured to send a proof report to the client, the proof report indicating the trustworthiness of an environment in which the target key is stored.

The units and/or modules included in the apparatus 700, the apparatus 800, and the apparatus 900 may be implemented in various ways, including software, hardware, firmware, or any combination thereof. In some embodiments, one or more units and/or modules may be implemented using software and/or firmware, for example machine executable instructions stored on a storage medium. In addition to machine executable instructions or as an alternative, some or all units and/or modules in the apparatus 700 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), and so on.

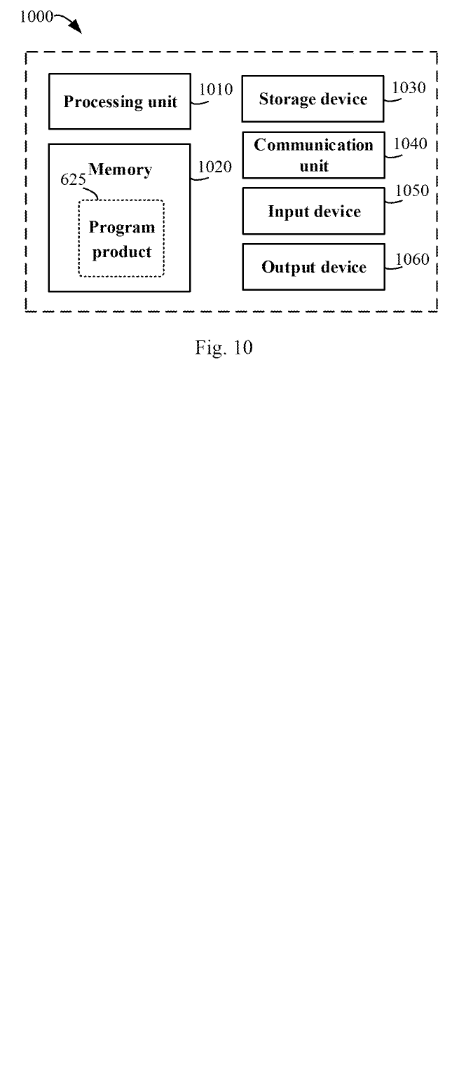

FIG. 10 illustrates a block diagram of an electronic device 1000 in which one or more embodiments of the present disclosure may be implemented. It should be understood that the electronic device 1000 shown in FIG. 10 is merely exemplary, without suggesting any limitation to the function and scope of the embodiments described herein.

As shown in FIG. 10, the electronic device 1000 is in a form of a general-purpose electronic device. Components of the electronic device 1000 may include, but are not limited to, one or more processors or processing units 1010, a memory 1020, a storage device 1030, one or more communication units 1040, one or more input devices 1050, and one or more output devices 1060. The processing unit 1010 may be an actual or virtual processor, and can perform various processing based on a program stored in the memory 1020. In a multi-processor system, a plurality of processing units perform computer executable instructions in parallel to improve the parallel processing capability of the electronic device 1000.

The electronic device 1000 typically includes a plurality of computer storage medium. Such medium may be any available medium accessible by the electronic device 1000, including, but not limited to, volatile and non-volatile medium, removable and non-removable medium. The memory 1020 may be a volatile memory (for example, a register, cache, a random access memory (RAM)), a non-volatile memory (such as a read-only memory (ROM), an electrically erasable programmable read-only memory (EEPROM), a flash memory), or any combination thereof. The storage device 1030 may be removable or non-removable medium, and may include a machine readable medium such as a flash drive, a disk, or any other medium, which can be used to store information and/or data and may be accessed within the electronic device 1000.

The electronic device 1000 may further include other removable/non-removable, volatile/non-volatile memory medium. Although not shown in FIG. 10, a disk driver for reading from or writing to a removable, non-volatile disk (such as a "floppy disk"), and an optical disk driver for reading from or writing to a removable, non-volatile optical disk may be provided. In these cases, each driver may be connected to a bus (not shown) via one or more data medium interfaces. The memory 1020 may include a computer program product 1025 having one or more program modules configured to perform various methods or acts of the various embodiments of the present disclosure.

The communication unit 1040 enables communication with other electronic devices via the communication medium. In addition, the functions of the components of the electronic device 1000 may be implemented by a single computing cluster or a plurality of computing machines, wherein the plurality of computing machines may communicate via communication connections. Therefore, the electronic device 1000 may use a logical connection with one or more other servers, a network personal computer (PC), or another network node to operate in a networked environment.

The input device 1050 may be one or more input devices, such as a mouse, a keyboard, a tracking ball, etc. The output device 1060 may be one or more output devices, such as a display, a speaker, a printer, etc. The electronic device 1000 may further communicate with one or more external devices (not shown) as needed via the communication unit 1040, the external devices such as a storage device, a display device, etc., communicate with one or more devices that enable a user to interact with the electronic device 1000, or communicate with any devices (for example, a network card, a modem, etc.) that enable the electronic device 1000 to communicate with one or more other electronic devices. Such communication may be performed via input/output (I/O) interfaces (not shown).

According to an exemplary implementation of the present disclosure, there is provided a computer-readable storage medium having computer executable instructions stored thereon, where the computer executable instructions are executed by a processor to implement the method described above. According to an exemplary implementation of the present disclosure, there is further provided a computer program product tangibly stored on a non-transitory computer-readable medium and including computer executable instructions, where the computer executable instructions are executed by a processor to implement the method described above.

Various aspects of the present disclosure are described herein with reference to the flowcharts and/or block diagrams of the method, the apparatus, the device, and the computer program product implemented according to the present disclosure. It should be understood that each block of the flowcharts and/or block diagrams, and any combination of the blocks in the flowcharts and/or block diagrams, may be implemented by computer-readable program instructions.

These computer-readable program instructions may be provided to a processing unit of a general-purpose computer, a special-purpose computer, or other programmable data processing apparatus to produce a machine, such that when the instructions are executed by the processing unit of the computer or other programmable data processing apparatus, an apparatus for implementing the functions/acts specified in one or more of the blocks of the flowcharts and/or block diagrams is produced. These computer-readable program instructions may also be stored in a computer-readable storage medium, and the instructions cause a computer, a programmable data processing apparatus, and/or other devices to work in a specific manner, such that the computer-readable medium storing the instructions includes a manufactured product, which includes instructions for implementing various aspects of the functions/acts specified in one or more blocks of the flowcharts and/or block diagrams.

The computer-readable program instructions may be loaded onto a computer, another programmable data processing apparatus, or other device, such that a series of operations and steps are performed on the computer, the another programmable data processing apparatus, or the other device to produce a computer-implemented process, such that the instructions executed on the computer, the another programmable data processing apparatus, or the other device implement the functions/acts specified in one or more blocks of the flowcharts and/or block diagrams.

The flowcharts and block diagrams in the drawings show the possibly implemented architectures, functions, and operations of the system, the method, and the computer program product according to a plurality of implementations of the present disclosure. In this regard, each block in the flowcharts or block diagrams may represent a module, a program segment, or a part of an instruction. The module, the program segment, or the part of the instruction contains one or more executable instructions for implementing a specified logical function. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and any combination of the blocks in the block diagrams and/or flowcharts, may be implemented by a dedicated hardware-based system that perform specified functions or acts, or may be implemented by a combination of dedicated hardware and computer instructions.

Various implementations of the present disclosure have been described above, and the foregoing description is exemplary, non-exhaustive, and is not limited to the disclosed implementations. Many modifications and variations will be apparent to those of ordinary skill in the art without departing from the scope and spirit of the illustrated implementations. The selection of terms used herein is intended to best explain the principles of the implementations, the actual application or improvement to the technology in the market, or to enable other persons of ordinary skill in the art to understand the implementations disclosed herein.

What is claimed is:

1. A data processing method, comprising:
obtaining initial prompt information generated based on a user input at a client;
encrypting the initial prompt information using a first key to obtain encrypted prompt information;
retrieving, from a plurality of encrypted knowledge segments, at least one first encrypted knowledge segment matching the encrypted prompt information, wherein the plurality of encrypted knowledge segments are encrypted using the first key; and
obtaining, using a machine learning model and based on the at least one first encrypted knowledge segment, a reply to the user input.

2. The method of claim 1, wherein obtaining the reply to the user input comprises:
decrypting the at least one first encrypted knowledge segment using the first key to obtain at least one first knowledge segment; and
obtaining the reply to the user input based on the at least one first knowledge segment and the initial prompt information.

3. The method of claim 1, wherein the user input is sent by a first user, and the plurality of encrypted knowledge segments are obtained by:
receiving indication information for a data object from a second user, wherein the data object is used for knowledge segment creation;
obtaining at least one knowledge segment for the data object by performing vectorization on at least one part of the data object; and
encrypting the at least one knowledge segment using the first key to obtain at least one encrypted knowledge segment as at least a part of the plurality of encrypted knowledge segments.

4. The method of claim 1, wherein the first key is obtained by:
sending a key request for the first key to a key management service in response to obtaining the initial prompt information; and
receiving the first key from the key management service.

5. The method of claim 2, wherein the first key is obtained by:
sending a key request for the first key to a key management service in response to a retrieval of the at least one first encrypted knowledge segment; and
receiving the first key from the key management service.

6. The method of claim 1, wherein the first key is obtained based on configuration at the client of a first user sending the user input.

7. The method of claim 1, wherein encrypting the initial prompt information using the first key comprises:
performing vectorization on the initial prompt information to obtain vectorized prompt information; and
encrypting the vectorized prompt information using the first key to obtain the encrypted prompt information.

8. The method of claim 2, wherein obtaining the reply to the user input comprises:
providing the initial prompt information and the at least one first knowledge segment to the machine learning model deployed in a trusted execution environment to obtain an output of the machine learning model; and
determining the reply to the user input based on the output of the machine learning model.

9. The method of claim 1, wherein the method is performed in a trusted execution environment.

10. A data processing method applied at a client, comprising:
presenting a key configuration interface;
configuring a first key based on a first operation on the key configuration interface; and
sending the first key to a key management service in response to the key management service passing verification.

11. The method of claim 10, further comprising:
receiving a user selection for a data object, wherein the data object is used for knowledge segment creation;
sending indication information for the data object to a knowledge service in response to the user selection; and
presenting reminder information indicating that a knowledge segment created based on the data object will be encrypted.

12. The method of claim 10, wherein the key management service is verified by:
receiving a proof report from the key management service, wherein the proof report indicates the trustworthiness of an environment storing the first key; and
verifying the key management service based on the proof report.

13. An electronic device, comprising:
at least one processing unit; and
at least one memory coupled to the at least one processing unit and storing instructions executable by the at least one processing unit, wherein the instructions, when executed by the at least one processing unit, cause the electronic device to perform a data processing method, and the data processing method comprises:
obtaining initial prompt information generated based on a user input at a client;
encrypting the initial prompt information using a first key to obtain encrypted prompt information;
retrieving, from a plurality of encrypted knowledge segments, at least one first encrypted knowledge segment matching the encrypted prompt information, the plurality of encrypted knowledge segments being encrypted using the first key; and
obtaining, using a machine learning model and based on the at least one first encrypted knowledge segment, a reply to the user input.

14. The electronic device of claim 13, wherein obtaining the reply to the user input comprises:
decrypting the at least one first encrypted knowledge segment using the first key to obtain at least one first knowledge segment; and
obtaining the reply to the user input based on the at least one first knowledge segment and the initial prompt information.

15. The electronic device of claim 13, wherein the user input is sent by a first user, and the plurality of encrypted knowledge segments are obtained by:
receiving indication information for a data object from a second user, the data object being used for knowledge segment creation;
obtaining at least one knowledge segment for the data object by performing vectorization on at least one part of the data object; and
encrypting the at least one knowledge segment using the first key to obtain at least one encrypted knowledge segment as at least a part of the plurality of encrypted knowledge segments.

16. The electronic device of claim 13, wherein the first key is obtained by:
sending a key request for the first key to a key management service in response to obtaining the initial prompt information; and
receiving the first key from the key management service.

17. The electronic device of claim 14, wherein the first key is obtained by:
sending a key request for the first key to a key management service in response to a retrieval of the at least one first encrypted knowledge segment; and
receiving the first key from the key management service.

18. The electronic device of claim 13, wherein the first key is obtained based on configuration at the client of a first user who sends the user input.

19. The electronic device of claim 13, wherein encrypting the initial prompt information using the first key comprises:
performing vectorization on the initial prompt information to obtain vectorized prompt information; and
encrypting the vectorized prompt information using the first key to obtain the encrypted prompt information.

20. A non-transitory computer-readable storage medium storing a computer program, wherein the computer program is executable by a processor to implement the method of claim 1.
